(19) United States
(12) Patent Application Publication
(10) Pub. No.: US 2024/0378851 A1
(43) Pub. Date: Nov. 14, 2024

(54) SCREEN DATA PROCESSING APPARATUS, METHOD, AND PROGRAM

(71) Applicant: NIPPON TELEGRAPH AND TELEPHONE CORPORATION, Tokyo (JP)

(72) Inventors: Shiro OGASAWARA, Musashino-shi, Tokyo (JP); Yoshiaki SHOJI, Musashino-shi, Tokyo (JP); Fumihiro YOKOSE, Musashino-shi, Tokyo (JP)

(73) Assignee: NIPPON TELEGRAPH AND TELEPHONE CORPORATION, Tokyo (JP)

(21) Appl. No.: 18/682,123

(22) PCT Filed: Sep. 8, 2021
(86) PCT No.: PCT/JP2021/033040

§ 371 Date: Feb. 8, 2024

(51) Int. Cl. G06V 10/74; G06V 30/10

(52) U.S. Cl. CPC G06V 10/74; G06V 30/10

(57) ABSTRACT

A screen data processing device according to one embodiment includes: a detection degree calculation unit that calculates a character string detection degree indicating, based on screen component information in which information of a character string serving as a component of screen data is managed and an area of part of an image displayed on a display screen, how many character strings managed by the screen component information are drawn in the area; and a determination unit that determines whether or not the character string managed by the screen component information is drawn in the area on the basis of a magnitude of the character string detection degree calculated by the detection degree calculation unit.

### TECHNICAL FIELD

Embodiments of the present invention relate to a screen data processing device, method, and program.

### BACKGROUND ART

There has been proposed a technique of acquiring and accumulating text information displayed on a terminal screen when a consulter who is a business practitioner performs business and, when a trouble occurs, pairing a consulter and a possible consultant who is a business practitioner who can smoothly solve the trouble on the basis of the information, that is, so-called consulter matching technique (see, for example, Non Patent Literature 1).

In general, when the possible consultant receives a consultation on the basis of a solution case experienced in the past, for example, the possible consultant searches for a past document or a message on a communication tool or displays a past case again on a business system screen by himself/herself.

As a method of reducing the necessity of the above work by the possible consultant, for example, the consulter matching technique acquires not only text information displayed on a screen when a terminal is used, but also a screen image and a path of the document, records and accumulates the text information, the screen image, and the path of the document in association with each other, and presents the accumulated information to the possible consultant when the possible consultant receives a consultation.

### CITATION LIST

### Non Patent Literature

Non Patent Literature 1: Gyoumu keiken no suriawase ni yoru soudansha pairing gijutsu (in Japanese) (Consulter pairing technique by comparison between business experiences), R6-9, Tsukuba Forum 2020 ONLINE, Oct. 29, 2020-Oct. 30, 2020.

### SUMMARY OF INVENTION

### Technical Problem

A screen image acquired for the possible consultant as described above, text information acquired at the same timing as the screen image, and information of a screen component object that is a source of extracting the text information may be mismatched.

Examples of an occurrence trigger of this mismatching include switching of a tab on the screen, transition of the screen, reduction and expansion of a panel, and dynamic addition or deletion of a screen component.

When the mismatching occurs, the possible consultant cannot understand or use a case experienced in the past from a screen image in which the mismatching occurs.

Further, the possible consultant may be confused when a screen image irrelevant to the text information is presented.

One cause of the above mismatching is, for example, a difference in screen display timing. For example, a timing at which an application program whose screen data is to be acquired creates and updates information of a screen component object is different from a timing at which the application program draws a screen image.

Another cause thereof is a difference between the screen display timing and a screen acquisition timing. For example, a timing at which a program that acquires screen data acquires information of a screen component object and a screen image does not match with the screen display timing.

An anteroposterior relationship and time lag between the screen display timings depend on a platform, version, and load state of an operation environment of a graphical user interface (GUI) used for screen display. Thus, there is a limit to uniform handling by a general-purpose screen data acquisition program.

Further, it is inappropriate to block a screen operation in order to acquire data at a timing at which the screen has no change because blocking the screen operation hinders the possible consultant operating the terminal.

The present invention has been made in view of the above circumstances, and an object of the present invention is to provide a screen data processing device, method, and program capable of determining whether or not an image displayed on a display screen matches with a component managed by screen component information.

### Solution to Problem

A screen data processing device according to one aspect of the present invention includes: a detection degree calculation unit that calculates a character string detection degree indicating, based on screen component information in which information of a character string serving as a component of screen data is managed and an area of part of an image displayed on a display screen, how many character strings managed by the screen component information are drawn in the area; and a determination unit that determines whether or not the character string managed by the screen component information is drawn in the area on the basis of a magnitude of the character string detection degree calculated by the detection degree calculation unit.

A screen data processing method according to one aspect of the present invention is a method performed by a screen data processing device, in which: the screen data processing method includes a detection degree calculation step that calculates a character string detection degree indicating, based on screen component information in which information of a character string serving as a component of screen data is managed and an area of part of an image displayed on a display screen, how many character strings managed by the screen component information are drawn in the area, and a determination step that determines whether or not the character string managed by the screen component information is drawn in the area on the basis of a magnitude of the character string detection degree calculated by the detection degree calculation step.

### Advantageous Effects of Invention

The present invention can determine whether or not an image displayed on a display screen matches with a component managed by screen component information.

### BRIEF DESCRIPTION OF DRAWINGS

FIG. 1 shows an application example of a screen data processing device according to an embodiment of the present invention.

FIG. 2 shows an example of details of a function of a screen data matching inspection unit of a screen data processing device.

FIG. 3 shows an example of details of a function of a screen data display unit of a screen data processing device.

FIG. 4 shows a configuration example of information of screen component objects in a table format.

FIG. 5 shows an example of a relationship between a plurality of screen component objects in information of the screen component objects.

FIG. 6 shows an example of a screen image.

FIG. 7 shows an example of attributes of a screen in a table format.

FIG. 8 is a flowchart showing an example of a processing operation of a screen data processing device.

FIG. 9 shows an example of inspection of screen data matching by a screen data processing device.

FIG. 10 shows an example of display character string presence/absence determination using a threshold.

FIG. 11 shows an example of display character string presence/absence determination using a reference for mismatching and a reference for matching.

FIG. 12 is a flowchart showing an example of a processing operation in which a screen data processing device calculates a reference for mismatching.

FIG. 13 shows an example where a screen data processing device calculates a reference for mismatching.

FIG. 14 is a flowchart showing an example of a processing operation in which a screen data processing device calculates a reference for matching.

FIG. 15 shows an example where a screen data processing device calculates a reference for matching.

FIG. 16 is a flowchart showing an example of a processing operation in which a screen data processing device calculates a character string detection degree decrease rate.

FIG. 17 shows an example of a character string detection degree calculated for a pseudo matching image.

FIG. 18 shows an example of a reference for matching calculated according to a character string detection degree decrease rate.

FIG. 19 shows an example of collection of matching images.

FIG. 20 is a block diagram showing an example of a hardware configuration of a screen data processing device according to an embodiment of the present invention.

### DESCRIPTION OF EMBODIMENTS

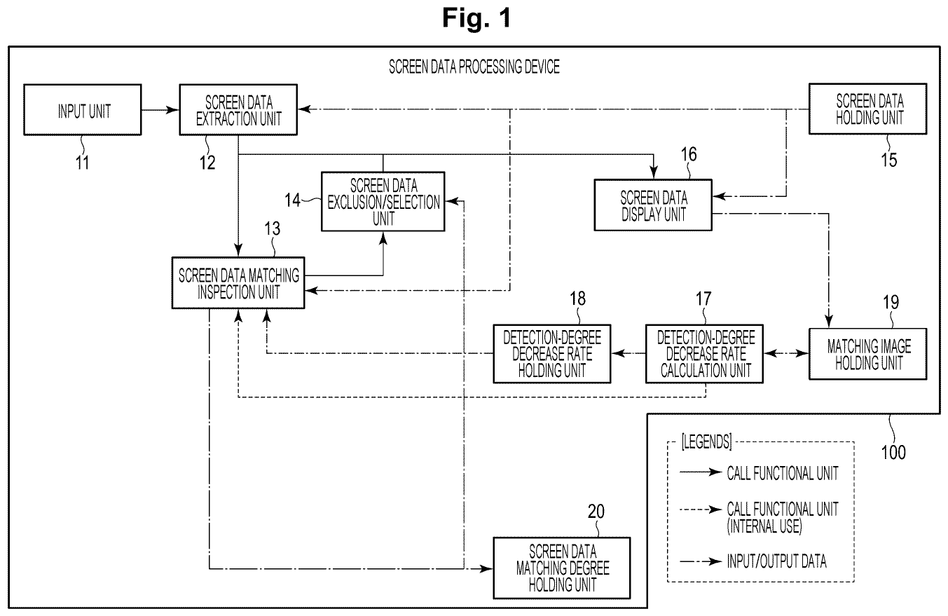

Hereinafter, an embodiment according to the present invention will be described with reference to the drawings. FIG. 1 shows an application example of a screen data processing device according to an embodiment of the present invention.

As shown in FIG. 1, a screen data processing device 100 according to an embodiment of the present invention includes an input unit 11, a screen data extraction unit 12, a screen data matching inspection unit 13, a screen data exclusion or selection unit 14, a screen data holding unit 15, a screen data display unit 16, a detection-degree decrease rate calculation unit 17, a detection-degree decrease rate holding unit 18, a matching image holding unit 19, and a screen data matching degree holding unit 20.

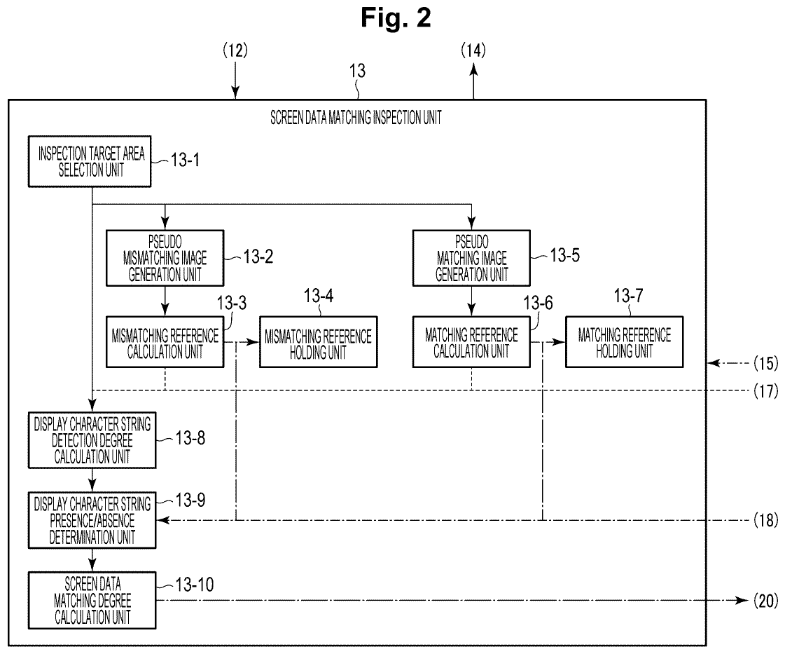

FIG. 2 shows an example of details of a function of the screen data matching inspection unit of the screen data processing device.

As shown in FIG. 2, the screen data matching inspection unit 13 of the screen data processing device 100 includes an inspection target area selection unit 13-1, a pseudo mismatching image generation unit 13-2, a mismatching reference calculation unit 13-3, a mismatching reference holding unit 13-4, a pseudo matching image generation unit 13-5, a matching reference calculation unit 13-6, a matching reference holding unit 13-7, a display character string detection degree calculation unit 13-8, a display character string presence/absence determination unit 13-9, and a screen data matching degree calculation unit 13-10.

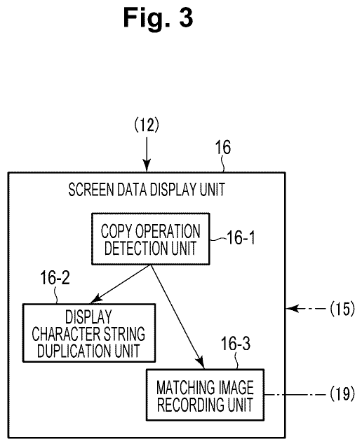

FIG. 3 shows an example of details of a function of the screen data display unit of the screen data processing device.

As shown in FIG. 3, the screen data display unit 16 of the screen data processing device 100 includes a copy operation detection unit 16-1, a display character string duplication unit 16-2, and a matching image recording unit 16-3. Details of functions of the above units shown in FIGS. 1 to 3 will be described later.

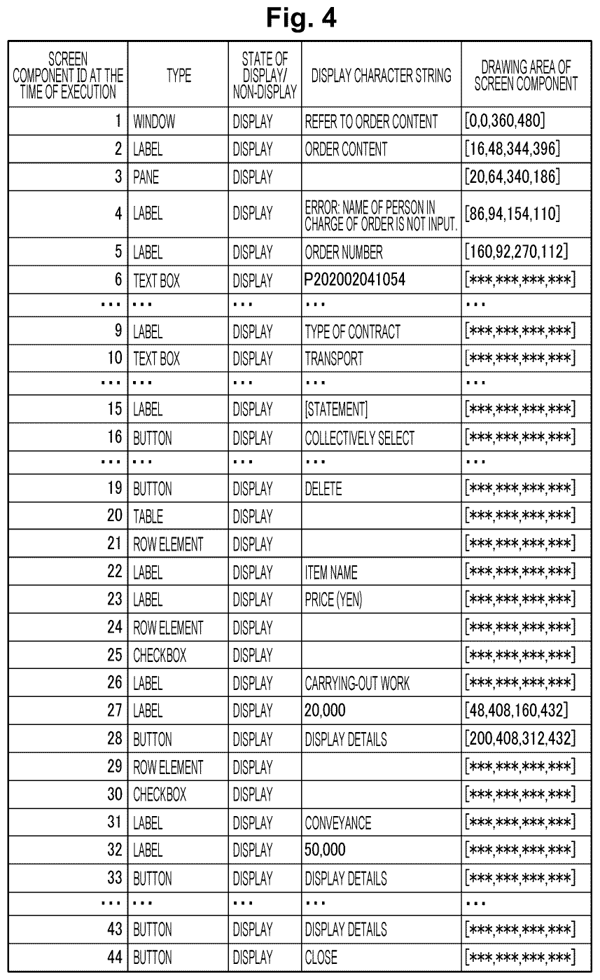

FIG. 4 shows a configuration example of information of screen component objects in a table format.

The screen component objects in FIG. 4 are information held by the screen data holding unit 15 in screen data regarding a certain screen displayed in the past. A screen component ID, a type, a state of display or non-display, a display character string, and a drawing area of a screen component in a screen image are shown for each of the plurality of screen component objects.

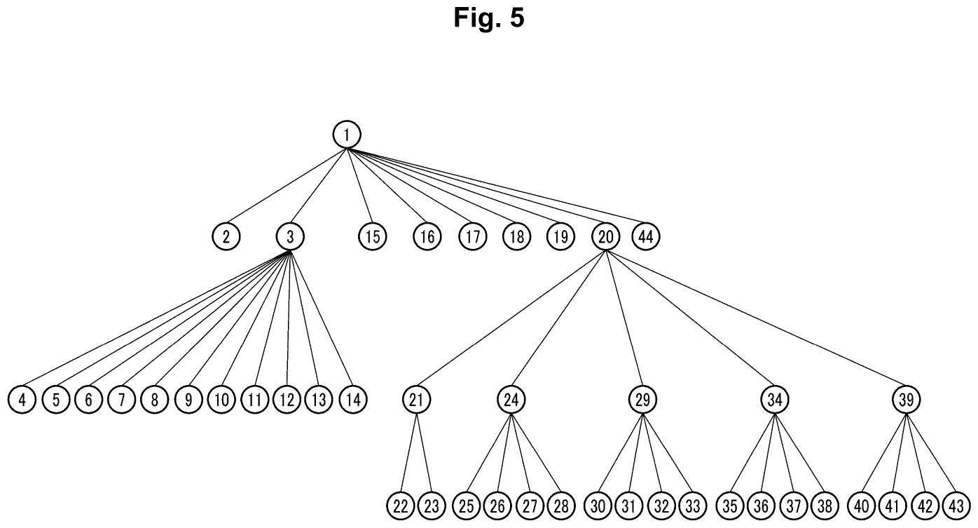

FIG. 5 shows an example of a relationship between the plurality of screen component objects in the information of the screen component objects.

The example of FIG. 5 shows, in the form of a tree, a relationship between screen component objects corresponding to the screen component IDs “1” to “44” shown in FIG. 4 which are information held by the screen data holding unit 15 in the same screen data as screen data corresponding to the information shown in FIG. 4.

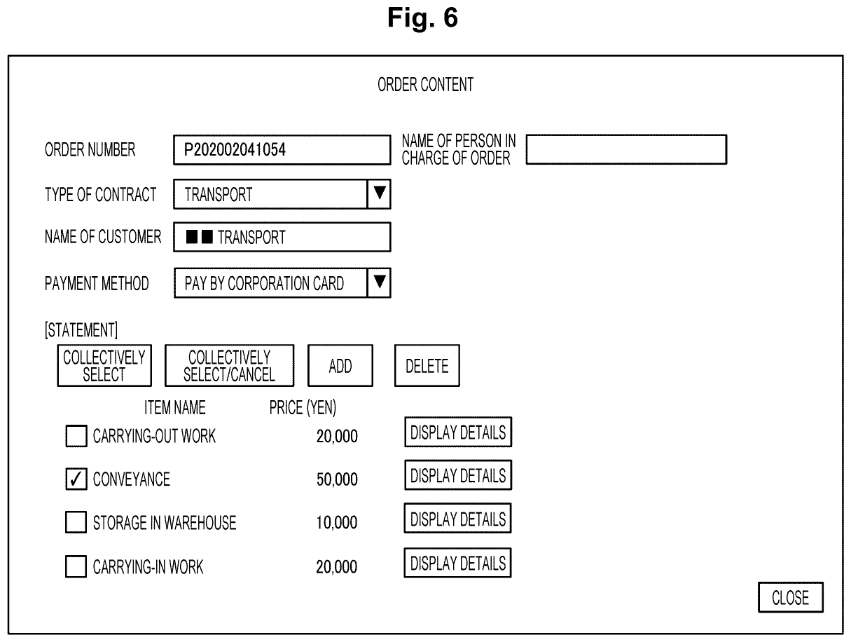

FIG. 6 shows an example of a screen image.

The example of FIG. 6 shows, as the screen image, a confirmation screen of order content of an article in the same screen data as the screen data corresponding to the information shown in FIG. 4.

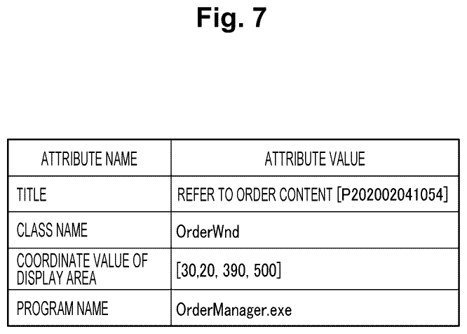

FIG. 7 shows an example of attributes of a screen in a table format.

The example of FIG. 7 shows a title, a class name, coordinate values of a display area, and a program name as the attributes of the screen image in the same screen data as the screen data corresponding to the information shown in FIG. 4. Various pieces of information in FIGS. 4 to 7 are information regarding the same screen. In the present embodiment, a set of those pieces of information is referred to as screen data.

Next, an example of a processing operation of the screen data processing device 100 will be described. First, a basic processing operation of the screen data processing device 100 will be described.

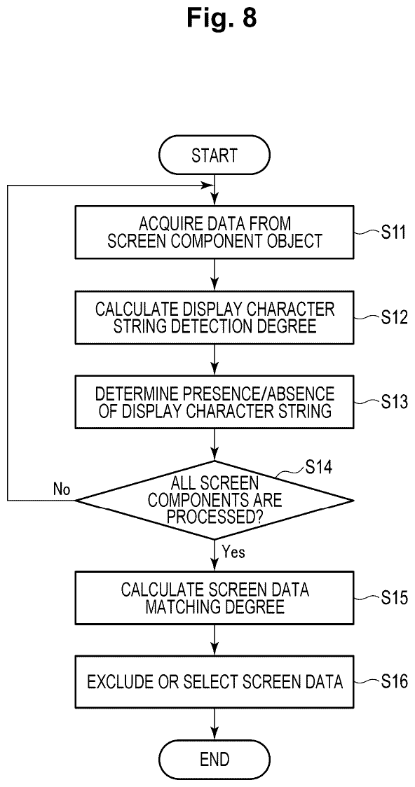

FIG. 8 is a flowchart showing an example of the processing operation of the screen data processing device.

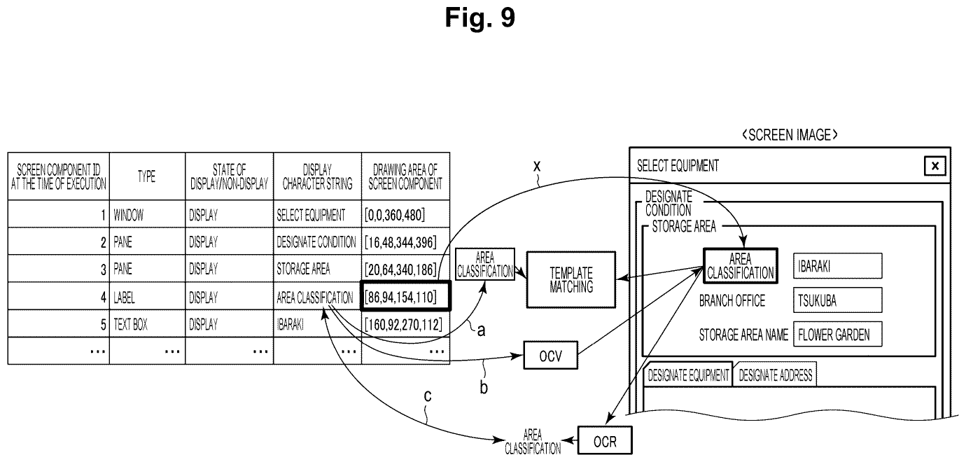

FIG. 9 shows an example of inspection of screen data matching by the screen data processing device.

The screen data processing device 100 compares information of screen component objects with a screen image and inspects whether or not the information and the screen image match with each other.

The screen data processing device 100 calculates, for each screen component, a character string detection degree d indicating how many display character strings can be detected in the screen image among display character strings obtained from the information of the screen component object, compares the character string detection degree d with a threshold do to determine whether or not a display character string is drawn, that is, whether or not a display character string is appropriately drawn in the screen image.

Further, the screen data processing device 100 calculates a screen data matching degree that is a ratio of screen components in which it is determined that the display character string is drawn in the screen image to screen components in the information of the screen component objects and ranks or selects screen data on the basis of the screen data matching degree.

In this processing operation, the information of the screen component objects and the screen image are compared to inspect whether or not both the information of the screen component objects and the screen image match with each other.

By this inspection, a screen image that does not match with the information of the screen component objects can be excluded from a target to be presented to a user, for example, the possible consultant.

A combination of text information and a screen image matching with the information of the screen component objects or a combination thereof more matching with the information of the screen component objects can be selected and presented to the user.

The screen data holding unit 15 stores information of screen component objects and information of a screen image in screen data regarding a screen displayed in the past. The screen data extraction unit 12 extracts the screen data held by the screen data holding unit 15 on the basis of a screen data extraction condition input by the input unit 11 and acquires, for each screen component, the state of display/non-display, the drawing area of the screen component, and the display character string in the information of the screen component object of the screen data. The inspection target area selection unit 13-1 of the screen data matching inspection unit 13 specifies the screen component object and an inspection target area in the screen image on the basis of the acquisition result (reference sign x in FIG. 9) (S11).

Next, the display character string detection degree calculation unit 13-8 calculates the character string detection degree d for each screen component displayed in the screen image, that is, how many display character strings are detected from the drawing area of the screen component object (S12).

The example of FIG. 9 shows three types of character string inspection methods, and the character string detection degree d can be calculated by any of the inspection methods.

In a first character string inspection method, after the specification in S11, a collation image in which a display character string “area classification” in the screen component object is drawn is generated (reference sign a in FIG. 9), then an image of the inspection target area is extracted from the screen image, and the collation image and the extracted image are collated by template matching, thereby calculating a matching degree between the collated images as the character string detection degree d₊.

In a second character string inspection method, after the specification in S11, the display character string “area classification” in the screen component object is extracted (reference sign b in FIG. 9), then an image of the inspection target area is extracted from the screen image, and the display character string “area classification” and a character string shown in the image of the inspection target area are collated by optical character verification (OCV), thereby verifying whether or not the display character string “area classification” in the screen component object is drawn in the image of the inspection target area. A degree of success of the collation is calculated as the character string detection degree d₊.

In a third character string inspection method, after the specification in S11, the display character string “area classification” in the screen component object is extracted (reference sign c in FIG. 9), then an image of the inspection target area is extracted from the screen image, and a character string shown in the image is read by optical character recognition (OCR). Then, the read character string is collated with the display character string “area classification” in the screen component object, thereby calculating a degree of similarity between both the character strings as the character string detection degree d₊.

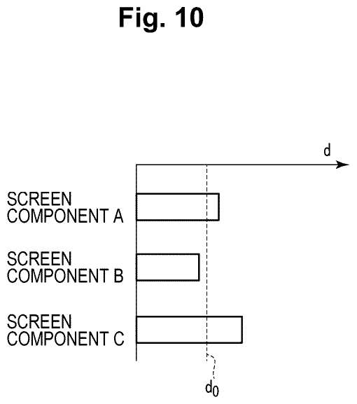

FIG. 10 shows an example of display character string presence/absence determination using a threshold.

The display character string presence/absence determination unit 13-9 compares the calculated character string detection degree with the threshold do (FIG. 10) of the character string detection degree to determine whether or not a display character string is drawn (whether or not a display character string is appropriately drawn in the screen image) for each of the plurality of screen components indicated by the information of the screen component objects (S13). When the processing from S11 to S13 is not completed for each of the plurality of screen components indicated by the information of the screen component objects in the same screen (No in S14), the processing returns to S11, and the processing from S11 to S13 is performed on unprocessed screen components among the plurality of screen components.

FIG. 10 shows an example of determination on whether or not a display character string is drawn based on the character string detection degree.

In the example of FIG. 10, the character string detection degree d is calculated for each of three types of screen components, here, a screen component A, a screen component B, and a screen component C, managed by the information of the screen component objects.

The character string detection degree d calculated for the screen component A is higher than the threshold do. Thus, a result of the determination on whether or not a display character string is drawn for the screen component A is “A display character string is drawn”. The character string detection degree d calculated for the screen component B is lower than the threshold do. Thus, a result of the determination on whether or not a display character string is drawn for the screen component B is “No display character string is drawn”. The character string detection degree d calculated for the screen component C is higher than the threshold do. Thus, a result of the determination on whether or not a display character string is drawn for the screen component C is “A display character string is drawn”.

In the present embodiment, in a case where the calculated character string detection degree d is equal to the threshold do, a result of the determination on whether or not a display character string is drawn is “A display character string is drawn”.

When the processing from S11 to S13 is completed for each of the plurality of screen components indicated by the information of the screen component objects in the same screen (Yes in S14), the screen data matching degree calculation unit 13-10 calculates the screen data matching degree for each of a plurality of screen images on the basis of the determination in S13. The screen data matching degree is a ratio of the screen components in which it is determined in S13 that the display character string is drawn to the plurality of screen components indicated by the information of the screen component objects. The calculation results are held by the screen data matching degree holding unit 20 (S15).

Based on the screen data matching degree calculated in S15 for each of the plurality of screen images, the screen data exclusion or selection unit 14 can exclude a screen image having the matching degree equal to or lower than a certain degree from a target to be presented by the screen data display unit 16 to the user or can display information in which a plurality of screen images is arranged according to the magnitude of the screen data matching degree on the screen data display unit 16 (S16).

This makes it possible to prevent an image irrelevant to the display character string of the screen component from being displayed on a screen and to eliminate confusion for the user by presenting an irrelevant screen image.

Next, another example of the determination on whether or not a display character string is drawn based on the character string detection degree in the processing operation of the screen data processing device 100 will be described.

In the above description, the character string detection degree is calculated by using the template matching, OCV, or OCR. However, the character string detection degree to be calculated and difficulty of detection change due to factors such as a difference in display character string of each screen component, a difference in background of a screen on which a display character string is drawn for each screen component, and a difference in setting for language or character type in OCR. Therefore, in the methods of determining presence/absence of a display character string by using the certain threshold do as described above, even in a case where a character string of a screen image matches with a display character string in information of a screen component object, this matching is not always reliably determined.

Therefore, the following is another example of the determination on whether or not a display character string is drawn based on the character string detection degree. A character string detection degree (also simply referred to as a reference for matching) dᵤₚₚₑᵣ and a character string detection degree (also simply referred to as a reference for mismatching) d_{lower} are dynamically generated according to screen data and a display character string to be inspected. The character string detection degree dᵤₚₚₑᵣ is a reference of determination that the display character string and a screen image match with each other, that is, a reference of determination that a result of the determination on whether or not a display character string is drawn is “A display character string is present”. The character string detection degree dower is a reference of determination that the display character string and the screen image do not match with each other, that is, a reference of determination that a result of the determination on whether or not a display character string is drawn is “No display character string is present”. Those references are used instead of the threshold do and are compared with the above calculated character string detection degree, thereby determining whether or not a display character string is drawn.

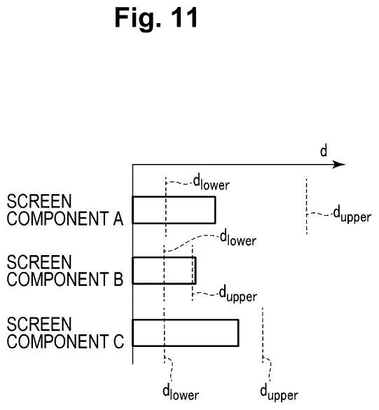

FIG. 11 shows an example of display character string presence/absence determination using the reference for mismatching and the reference for matching.

In the example of FIG. 11, the character string detection degree d is calculated for each of the three types of screen components, here, the screen component A, the screen component B, and the screen component C, managed by the information of the screen component objects, then the reference dᵤₚₚₑᵣ for matching and the reference d_{lower} for mismatching are calculated for the screen component A, the reference dᵤₚₚₑᵣ for matching and the reference d_{lower} for mismatching are calculated for the screen component B, and the reference dᵤₚₚₑᵣ for matching and the reference d_{lower} for mismatching are calculated for the screen component C.

The character string detection degree d calculated for the screen component A is between the reference d_{lower} for mismatching and the reference dᵤₚₚₑᵣ for matching calculated for the screen component A and is closer to the reference d_{lower} for mismatching than to the reference dᵤₚₚₑᵣ for matching, that is, is lower than an average of the reference d_{lower} for mismatching and the reference dᵤₚₚₑᵣ for matching. Thus, a result of the determination on whether or not a display character string is drawn for the screen component A is “No display character string is drawn”.

The character string detection degree d calculated for the screen component B is higher than the reference dᵤₚₚₑᵣ for matching calculated for the screen component B. Thus, a result of the determination on whether or not a display character string is drawn for the screen component B is “A display character string is drawn”.

The character string detection degree d calculated for the screen component C is between the reference d_{lower} for mismatching and the reference dᵤₚₚₑᵣ for matching calculated for the screen component C and is closer to the reference dᵤₚₚₑᵣ for matching than to the reference d_{lower} for mismatching, that is, is higher than an average of the reference d_{lower} for mismatching and the reference dᵤₚₚₑᵣ for matching. Thus, a result of the determination on whether or not a display character string is drawn for the screen component C is “A display character string is drawn”.

The above determination eliminates difficulty of selecting the threshold do so as not to cause an error in character string detection determination due to the differences of the above factors or cause an error in character string detection determination in a situation where there is a difference between the above factors.

Therefore, a change in difficulty of detection can be reflected also in the calculation result of the screen data matching degree.

Next, details of generation of the reference d_{lower} for mismatching will be described.

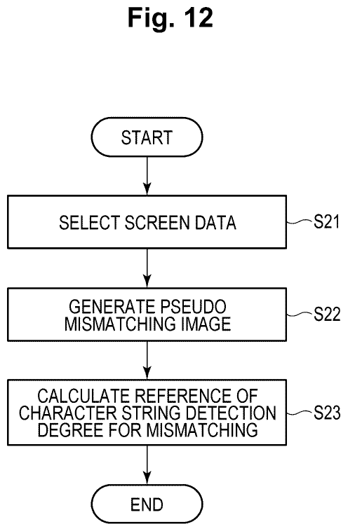

FIG. 12 is a flowchart showing an example of a processing operation in which the screen data processing device calculates the reference for mismatching.

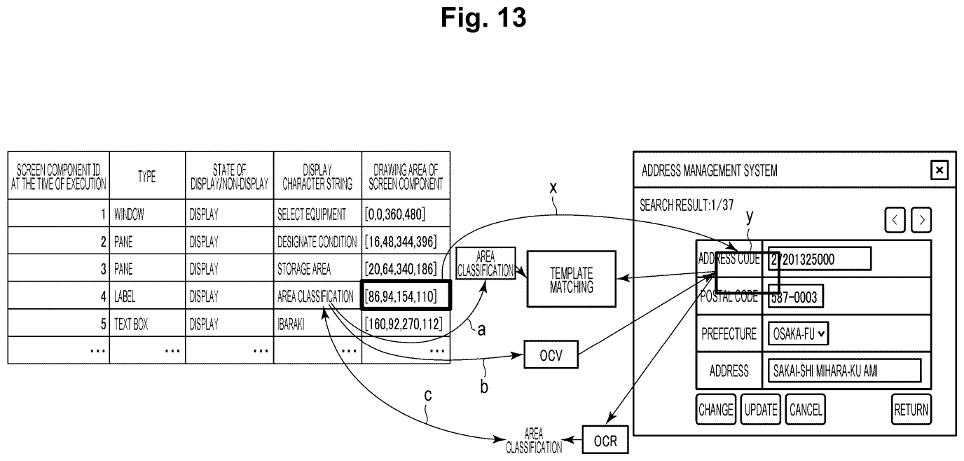

FIG. 13 shows an example where the screen data processing device calculates the reference for mismatching.

First, the pseudo mismatching image generation unit 13-2 selects one or more pieces of obviously mismatching screen data from screen data acquired by a screen data acquisition program (reference sign x in FIG. 13) (S21).

For example, in S21, screen data, which is acquired at a timing at which an operation target application of inspection target screen data is not executed, is selected.

Then, the pseudo mismatching image generation unit 13-2 selects, as a pseudo mismatching area, one or more areas at arbitrary positions in a screen image of the screen data selected in S21, each of the areas having the same size as a drawing area of an inspection target screen component and corresponding to an area that does not match with the screen component, and extracts an image in the area as a pseudo mismatching image (S22).

The mismatching reference calculation unit 13-3 calculates a character string detection degree d₊ for the pseudo mismatching image generated in S22, calculates the calculated character string detection degree d₊ as the reference d_{lower} of the character string detection degree for mismatching, and holds the calculation result in the mismatching reference holding unit 13-4 (S23). That is, “d_{lower}=d-” is established.

In a case where a plurality of pseudo mismatching images is extracted in S22, for example, a median value of the character string detection degrees d-calculated for the respective pseudo mismatching images may be used to eliminate an influence in which an area where the same character string as the display character string is drawn is accidentally used as much as possible.

In the example of FIG. 13, the character string detection degree d₊ can be calculated by any of the three types of character string inspection methods also shown in FIG. 9.

In the first character string inspection method, after the pseudo mismatching image is generated in S22, a collation image in which the display character string “area classification” in the screen component object is drawn is generated (reference sign a in FIG. 13), then the collation image and the pseudo mismatching image (reference sign y in FIG. 13) are collated by template matching, thereby calculating a matching degree between the collated images as the character string detection degree d₊.

In the second character string inspection method, after the pseudo mismatching image is generated in S22, the display character string “area classification” in the screen component object is extracted (reference sign b in FIG. 13), and the display character string “area classification” and a character string shown in the pseudo mismatching image are collated by OCV, thereby verifying whether or not the display character string “area classification” in the screen component object is drawn in the pseudo mismatching image. A degree of success d₊ of the collation is calculated as the character string detection degree d₊.

In the third character string inspection method, after the pseudo mismatching image is generated in S22, the display character string “area classification” in the screen component object is extracted (reference sign c in FIG. 13), and a character string shown in the pseudo mismatching image is read by OCR. Then, the read character string is collated with the display character string “area classification” in the screen component object, thereby calculating the degree of similarity between both the character strings as the character string detection degree d₊.

Next, details of generation of the reference dᵤₚₚₑᵣ for matching will be described.

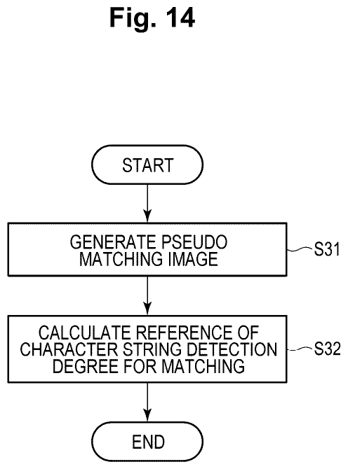

FIG. 14 is a flowchart showing an example of a processing operation in which the screen data processing device calculates the reference for matching.

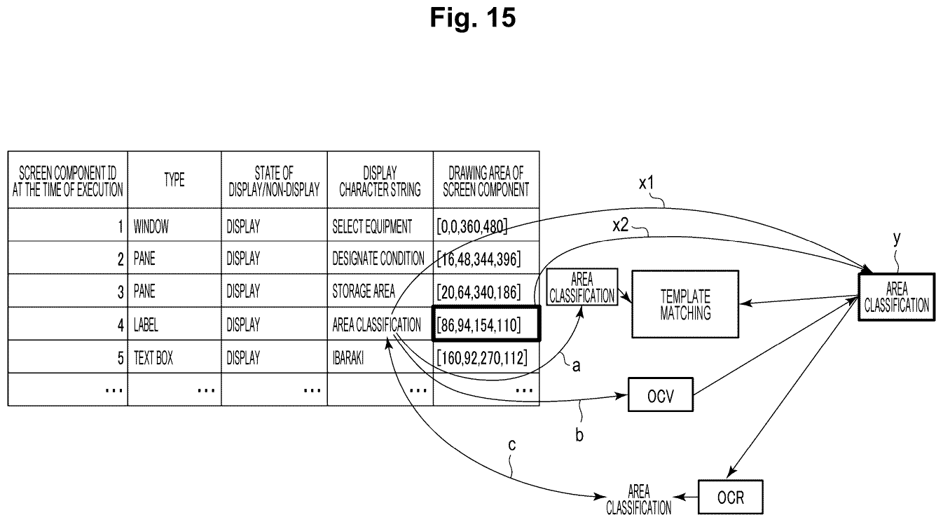

FIG. 15 shows an example where the screen data processing device calculates the reference for matching.

First, the pseudo matching image generation unit 13-5 generates a pseudo matching image from the information of the screen component objects (reference signs x1 and x2 in FIG. 15) (S31).

The pseudo matching image has a drawing area having the same size as the drawing area of the screen component and corresponds to an area where the display character string is drawn, that is, an area matching with the screen component.

A plurality of pseudo matching images may be generated by changing the type of background or font prepared in advance.

Next, the matching reference calculation unit 13-6 calculates a character string detection degree d₊ for the pseudo matching image generated in S31, calculates the calculated character string detection degree d₊ as the reference dumper of the character string detection degree for matching, and holds the calculation result in the matching reference holding unit 13-7 (S33). That is, “dᵤₚₚₑᵣ=d₊” is established.

In a case where a plurality of pseudo matching images is created in S32, a worst value, an average value, or a median value of the character string detection degrees d₊ calculated for the respective pseudo matching images can be used for subsequent processing.

In the example of FIG. 15, the character string detection degree d₊ can be calculated by any of the three types of character string inspection methods also shown in FIG. 9 and the like.

In the first character string inspection method, after the pseudo matching image is generated in S32, a collation image in which the display character string “area classification” in the screen component object is drawn is generated (reference sign a in FIG. 15), then the collation image and the pseudo matching image (reference sign y in FIG. 15) are collated by template matching, thereby calculating a matching degree between the collated images as the character string detection degree d₊.

In the second character string inspection method, after the pseudo matching image is generated in S32, the display character string “area classification” in the screen component object is extracted (reference sign b in FIG. 15), and the display character string “area classification” and a character string shown in the pseudo matching image are collated by OCV, thereby verifying whether or not the display character string “area classification” in the screen component object is drawn in the pseudo matching image. A degree of success of the collation is calculated as the character string detection degree d₊.

In the third character string inspection method, after the pseudo mismatching image is generated in S32, the display character string “area classification” in the screen component object is extracted (reference sign c in FIG. 15), and the character string shown in the pseudo matching image is read by OCR. Then, the read character string is collated with the display character string “area classification” in the screen component object, thereby calculating the degree of similarity between both the character strings as the character string detection degree d₊.

Next, another example of details of generation of the reference dᵤₚₚₑᵣ for matching will be described. This example is an improved example of the example described with reference to FIGS. 14 and 15.

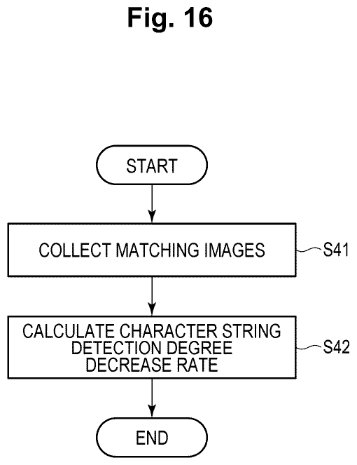

FIG. 16 is a flowchart showing an example of a processing operation in which the screen data processing device calculates a character string detection degree decrease rate.

The above pseudo matching image has a relatively simple background, and thus the character string detection degree d₊ tends to be calculated as a relatively high value according to the image.

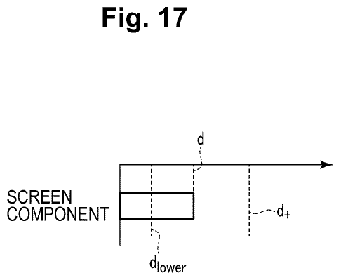

FIG. 17 shows an example of the character string detection degree calculated for a pseudo matching image.

FIG. 17 shows a relationship among the reference d_{lower} for mismatching calculated for the pseudo mismatching image, an actual character string detection degree d calculated for a screen component, and the character string detection degree d₊ calculated for the pseudo matching image. However, when the character string detection degree d₊ is calculated as a relatively high value as described above, an average of the reference d_{lower} for mismatching and the character string detection degree d+ calculated for the pseudo matching image is also a high value. Thus, a case where the character string detection degree d calculated for a matched screen component falls below the average, and it is determined that “No character string is drawn” tends to occur.

In the improved example, before screen data matching is inspected, a mechanism (=matching image collection function described later) for collecting matching images that satisfy all of the following matching image conditions (a), (b), and (c), without requiring work only for this purpose is prepared (S41).

### <Matching Image Conditions>

(a) A display character string is known.
(b) It is known that a display character string is drawn in a screen image.
(c) A drawing area of a screen component in a screen image is known.

For one or more matching images collected as described above, the detection-degree decrease rate calculation unit 17 first calculates, for each of the matching images, the character string detection degree d₊ of a pseudo matching image and then derives the character string detection degree d of the matching image.

The detection-degree decrease rate calculation unit 17 calculates a character string detection degree decrease rate r by d/d₊ and holds the calculation result in the detection-degree decrease rate holding unit 18 (S42).

In a case where there is a plurality of matching images, the worst value, the average value, or the median value of the character string detection degrees or the like calculated for the respective matching images may be used for subsequent processing.

When the screen data matching is inspected, a value, which is obtained by reflecting the above calculated character string detection degree decrease rate r in the character string detection degree d₊ calculated by using the pseudo matching image, is used as the reference dᵤₚₚₑᵣ for matching for each inspection target screen component. That is, dᵤₚₚₑᵣ=r×d₊ is established.

The character string detection degree itself greatly changes depending on a case such as a character string, but the character string detection degree decrease rate is less affected.

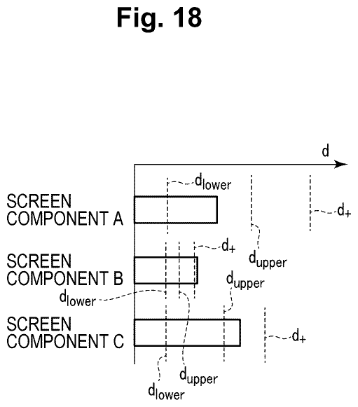

FIG. 18 shows an example of the reference for matching calculated according to the character string detection degree decrease rate.

In the example of FIG. 18, the character string detection degree d is calculated for each of the three types of screen components, here, the screen component A, the screen component B, and the screen component C, managed by the information of the screen component objects, then the character string detection degree d₊ and the reference d_{lower} for mismatching are calculated for the screen component A and the pseudo matching image, the character string detection degree d₊ and the reference d_{lower} for mismatching are calculated for the screen component B and the pseudo matching image, and the character string detection degree d₊ and the reference d_{lower} for mismatching are calculated for the screen component C and the pseudo matching image.

The character string detection degree d and the magnitude of the reference d_{lower} for mismatching in FIG. 18 are the same as the character string detection degree d and the magnitude of the reference d_{lower} for mismatching in FIG. 11.

The example of FIG. 18 shows an example of the reference dᵤₚₚₑᵣ for matching for the screen component A based on the character string detection degree d₊ calculated for the screen component A and the above calculated character string detection degree decrease rate r, the reference dᵤₚₚₑᵣ for matching for the screen component B based on the character string detection degree d₊ calculated for the screen component B and the above calculated character string detection degree decrease rate r, and the reference dᵤₚₚₑᵣ for matching for the screen component C based on the character string detection degree de calculated for the screen component C and the above calculated character string detection degree decrease rate r. The magnitude of the character string detection degree d₊ in FIG. 18 is the same as the magnitude of the reference dᵤₚₚₑᵣ for matching in FIG. 11.

The character string detection degree d calculated for the screen component A is between the reference d_{lower} for mismatching and the reference dᵤₚₚₑᵣ for matching calculated for the screen component A and is closer to the reference dᵤₚₚₑᵣ for matching than to the reference d_{lower} for mismatching, that is, is higher than an average of the reference d_{lower} for mismatching and the reference dᵤₚₚₑᵣ for matching. Thus, a result of the determination on whether or not a display character string is drawn for the screen component A is “A display character string is drawn”.

As a result, as compared with the example of FIG. 11 showing that a result of the determination on whether or not a display character string is drawn for the screen component A is “No display character string is drawn”, the example of FIG. 18 in which the reference dᵤₚₚₑᵣ for matching is newly calculated under a condition that the character string detection degree d and the magnitude of the reference d_{lower} for mismatching are the same as those in the example of FIG. 11 shows that a result of the determination on whether or not a display character string is drawn for the screen component A is changed to “A display character string is drawn”.

The character string detection degree d calculated for the screen component B is higher than the reference dᵤₚₚₑᵣ for matching calculated for the screen component B. Thus, a result of the determination on whether or not a display character string is drawn for the screen component B is “A display character string is drawn”.

The character string detection degree d calculated for the screen component C is between the reference d_{lower} for mismatching and the reference dᵤₚₚₑᵣ for matching calculated for the screen component C and is closer to the reference dᵤₚₚₑᵣ for matching than to the reference d_{lower} for mismatching, that is, is higher than an average of the reference d_{lower} for mismatching and the reference dᵤₚₚₑᵣ for matching. Thus, a result of the determination on whether or not a display character string is drawn for the screen component C is “A display character string is drawn”.

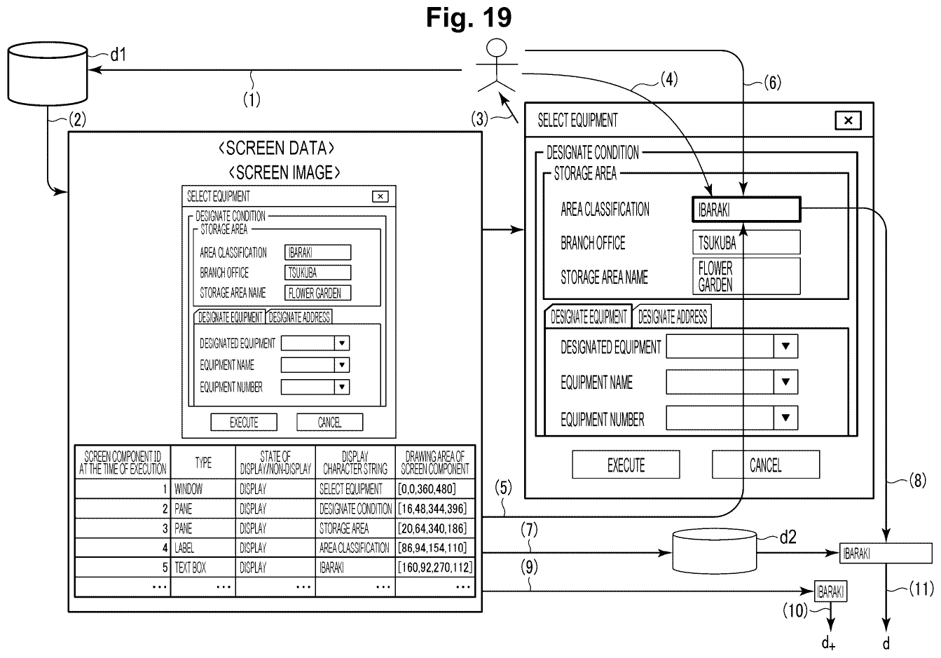

Next, details of collection of the matching images will be described. FIG. 19 shows an example of collection of matching images.

As the matching image collection function, for example, past screen data acquired by the screen data acquisition program, that is, information including a screen image and information of screen component objects is used.

The user or the consulter matching device inputs a screen data extraction condition, that is, a condition of desired screen data among pieces of screen data held by the screen data holding unit 15 ((1) in FIG. 19).

Based on the condition, the screen data extraction unit 12 extracts screen data from a set of the pieces of the screen data (d1 in FIG. 19) held by the screen data holding unit 15 and presents a screen image in the screen data ((2) in FIG. 19) to the user ((3) in FIG. 19).

Therefore, the user can refer to the screen displayed in the past, without searching for a communication tool, the material, or the like by himself/herself.

When referring to the screen displayed in the past, the user desires to use a specific display character string drawn in the screen image in many cases. Here, in response to an input operation from the user, a desired point or area where the character string to be used is drawn is designated in the screen image of the past screen data displayed on the screen data display unit 16 ((4) in FIG. 19).

The screen data display unit 16 selects (specifies) a screen component corresponding to the designated point or area from the information of the screen component objects held by the screen data holding unit 15 and emphasizes a drawing area of the screen component with highlight, a rectangular frame, or the like such that the user can visually recognize the drawing area ((5) in FIG. 19).

The copy operation detection unit 16-1 of the screen data display unit 16 detects a user's input operation regarding copying of the emphasized character string, and the display character string duplication unit 16-2 copies a display character string of the emphasized screen component ((6) in FIG. 19).

The display character string duplication unit 16-2 temporarily stores the copied display character string of the screen component in a clipboard (d2 in FIG. 19) ((7) in FIG. 19).

The matching image recording unit 16-3 determines that an image in the drawing area of the stored screen component satisfies the matching image conditions, extracts the corresponding image in the drawing area as the matching image, and holds the matching image in the matching image holding unit 19 ((8) in FIG. 19).

Here, in order to collect many cases in a short period of time, screen components included in the same screen data other than the screen components to be copied may also be added as the matching image. Further, in order to further increase accuracy of determination on whether or not an image satisfies the matching image conditions, whether or not the copied screen component is pasted may be added to the above determination conditions.

Then, the pseudo matching image generation unit 13-5 generates a pseudo matching image according to the display character string of the screen component selected (specified) from the information of the screen component objects ((9) in FIG. 19), and the detection-degree decrease rate calculation unit 17 calculates the character string detection degree d₊ according to the pseudo matching image and calculates the character string detection degree d according to the matching image held by the matching image holding unit 19 as described above ((10) in FIG. 19).

Then, the character string detection degree decrease rate r is calculated according to the calculated character string detection degree d₊ and character string detection degree d ((11) in FIG. 19), and the reference dᵤₚₚₑᵣ for matching described above is calculated according to the character string detection degree decrease rate r, thereby determining whether or not a display character string is drawn.

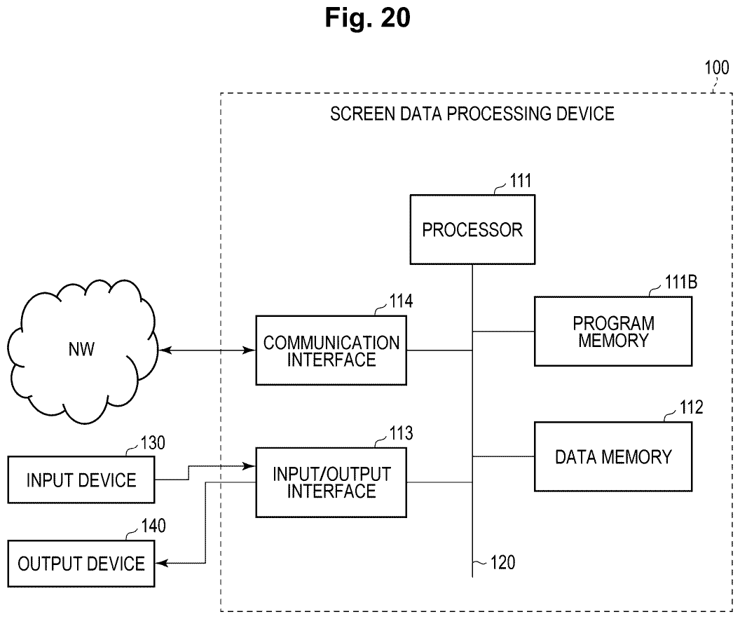

FIG. 20 is a block diagram showing an example of a hardware configuration of the screen data processing device according to the embodiment of the present invention. In the example of FIG. 20, the screen data processing device 100 is configured by, for example, a server computer or a personal computer and includes a hardware processor 111 such as a central processing unit (CPU). The hardware processor 111 is connected to a program memory 111B, a data memory 112, an input/output interface 113, and a communication interface 114 via a bus 120.

The communication interface 114 includes, for example, one or more wireless communication interface units and enables transmission and reception of information to and from a communication network NW. A wireless interface can be, for example, an interface adopting a low-power wireless data communication standard, such as a wireless local area network (LAN).

The input/output interface 113 is connected to an input device 130 and output device 140 for an operator attached to the screen data processing device 100. The input/output interface 113 performs processing of fetching operation data input by an operator through the input device 130 such as a keyboard, a touch panel, a touchpad, or a mouse and outputting output data to the output device 140 including a display device made from liquid crystal, organic electro-luminescence (EL), or the like to display the output data. For the input device 130 and the output device 140, a device built in the screen data processing device 100 may be used, or an input device and output device of another information terminal that can communicate with the screen data processing device 100 may be used via the communication network NW.

The program memory 111B is used as a non-transitory tangible storage medium in, for example, a combination of a non-volatile memory that is writable and readable at any time, such as a hard disk drive (HDD) or a solid state drive (SSD), and a non-volatile memory such as a read only memory (ROM) and stores programs necessary for performing various types of processing according to the embodiment.

The data memory 112 is used as a tangible storage medium in a combination of, for example, the above non-volatile memory and a volatile memory such as a random access memory (RAM) and can be used to store various types of data acquired and created in the process of performing various types of processing.

The screen data processing device 100 according to the embodiment of the present invention may be configured as a data processing device including the input unit 11, the screen data extraction unit 12, the screen data matching inspection unit 13, the screen data exclusion or selection unit 14, the screen data display unit 16, and the detection-degree decrease rate calculation unit 17 in FIG. 1 as processing functional units by software.

A working memory used for various types of processing in the screen data processing device 100, the screen data holding unit 15, the detection-degree decrease rate holding unit 18, the matching image holding unit 19, and the screen data matching degree holding unit 20 in FIG. 1, and various holding units in the screen data matching inspection unit 13 can be configured by using the data memory 112 in FIG. 20.

The processing functional units of the respective units, such as the screen data extraction unit 12, the screen data matching inspection unit 13, the screen data exclusion or selection unit 14, the screen data display unit 16, and the detection-degree decrease rate calculation unit 17 in FIG. 1, can be implemented by causing the hardware processor 111 to read and execute the programs stored in the program memory 111B. Some or all of those processing functional units may be formed in other various modes including an integrated circuit such as an application specific integrated circuit (ASIC) or a field-programmable gate array (FPGA).

The methods described in each embodiment can be stored in a recording medium such as a magnetic disk (e.g. Floppy (registered trademark) disk or hard disk), an optical disc (e.g. CD-ROM, DVD, or MO), or a semiconductor memory (e.g. ROM, RAM, or flash memory) as a program (software means) which can be executed by a computer and can be distributed by being transmitted through a communication medium. Note that the programs stored in the medium also include a setting program for configuring, in the computer, software means (including not only an execution program but also a table and a data structure) to be executed by the computer. The computer that implements the present device executes the above processing by reading the programs recorded in the recording medium, constructing the software means by the setting program as needed, and controlling operation by the software means. Note that the recording medium described in the present specification is not limited to a recording medium for distribution, but includes a storage medium such as a magnetic disk or a semiconductor memory provided in a computer or in a device connected via a network.

The present invention is not limited to the above embodiments, and various types of modifications can be made at an implementation stage without departing from the gist of the invention. The embodiments may be implemented in appropriate combinations, and combined effects can be obtained in that case. The above embodiments include various types of inventions, and various types of inventions can be extracted in combinations selected from a plurality of disclosed components. For example, even if some components are eliminated from all the components described in the embodiments, a configuration from which the components are eliminated can be extracted as an invention as long as the problem can be solved and the effects can be obtained.

### REFERENCE SIGNS LIST

100 Screen data processing device
11 Input unit
12 Screen data extraction unit
13 Screen data matching inspection unit
13-1 Inspection target area selection unit
13-2 Pseudo mismatching image generation unit
13-3 Mismatching reference calculation unit
13-4 Mismatching reference holding unit
13-5 Pseudo matching image generation unit
13-6 Matching reference calculation unit
13-7 Matching reference holding unit
13-8 Display character string detection degree
calculation unit
13-9 Display character string presence/absence
determination unit
13-10 Screen data matching degree calculation unit
14 Screen data exclusion or selection unit
15 Screen data holding unit
16 Screen data display unit
16-1 Copy operation detection unit
16-2 Display character string duplication unit
16-3 Matching image recording unit
17 Detection-degree decrease rate calculation unit
18 Detection-degree decrease rate holding unit
19 Matching image holding unit
20 Screen data matching degree holding unit

1. A screen data processing device comprising:
detection degree calculation circuitry that calculates a character string detection degree indicating, based on screen component information in which information of a character string serving as a component of screen data is managed and an area of part of an image displayed on a display screen, how many character strings managed by the screen component information are drawn in the area; and
determination circuitry that determines whether or not the character string managed by the screen component information is drawn in the area on the basis of a magnitude of the character string detection degree calculated by the detection degree calculation circuitry.

2. The screen data processing device according to claim 1, wherein:
the screen component information is information in which the information of the character string is managed for each of a plurality of components of a screen;
the determination circuitry determines, for each of the plurality of components, whether or not the area of the part of the image displayed on the display screen matches with the character string managed by the screen component information; and
the screen data processing device further includes matching degree calculation circuitry calculates a screen data matching degree indicating a ratio of components in which it is determined that the area of the part of the image displayed on the display screen matches with the character string managed by the screen component information to the plurality of components on the basis of a determination result of each of the plurality of components by the determination circuitry.

3. The screen data processing device according to claim 1, further comprising:
first generation circuitry that generates a pseudo mismatching image corresponding to an area that has the same size as a drawing area of a screen component managed by the screen component information and does not match with the screen component;
second generation circuitry that generates a pseudo matching image corresponding to an area that has the same size as the drawing area of the screen component managed by the screen component information and matches with the screen component;
first calculation circuitry that calculates a character string detection degree indicating how many character strings managed by the screen component information are drawn in the pseudo mismatching image generated by the first generation circuitry; and
second calculation circuitry that calculates a character string detection degree indicating how many character strings managed by the screen component information are drawn in the pseudo matching image generated by the second generation circuitry,
wherein the determination circuitry determines whether or not the character string managed by the screen component information is drawn in the area on the basis of a relationship between calculation results by the first and second calculation circuitries and the character string detection degree calculated by the detection degree calculation circuitry.

4. The screen data processing device according to claim 3, further comprising:
third calculation circuitry that calculates a character string detection degree indicating how many character strings managed by the screen component information are drawn in a matching image matching with the screen component managed by the screen component information; and
decrease rate calculation circuitry that calculates a decrease rate from the character string detection degree calculated by the second calculation circuitry to the character string detection degree calculated by the third calculation circuitry on the basis of a relationship between the character string detection degree calculated by the second calculation circuitry and the character string detection degree calculated by the third calculation circuitry, wherein
the determination circuitry determines whether or not the character string managed by the screen component information is drawn in the area on the basis of a relationship among a value obtained by changing the character string detection degree calculated by the second calculation circuitry on the basis of the decrease rate calculated by the decrease rate calculation circuitry, the calculation result by the first calculation circuitry, and the character string detection degree calculated by the detection degree calculation circuitry.

5. The screen data processing device according to claim 4, further comprising:
a screen data memory to store past screen data; and
matching image extraction circuitry that extracts, as the matching image, an image of an area where a desired screen component is drawn in the screen data memory.

6. A screen data processing method, comprising:
calculating a character string detection degree indicating, based on screen component information in which information of a character string serving as a component of screen data is managed and an area of part of an image displayed on a display screen, how many character strings managed by the screen component information are drawn in the area; and
determining whether or not the character string managed by the screen component information is drawn in the area on the basis of a magnitude of the character string detection degree which was calculated.

7. The screen data processing method according to claim 6, wherein:
the screen component information is information in which the information of the character string is managed for each of a plurality of components of a screen;
the determining determines, for each of the plurality of components, whether or not a character string drawn in the area of the part of the image displayed on the display screen matches with the character string managed by the screen component information; and
the screen data processing method further comprises calculating a screen data matching degree indicating a ratio of components in which it is determined that the character string drawn in the area of the part of the image displayed on the display screen matches with the character string managed by the screen component information to the plurality of components on the basis of a determination result of each of the plurality of components by the determination step.

8. A non-transitory computer readable medium storing a screen data processing program for causing a processor to perform the screen data processing method of claim 6.
